(19) United States
(12) Patent Application Publication
(10) Pub. No.: US 2011/0212727 A1
(43) Pub. Date: Sep. 1, 2011

(54) METHOD FOR PROCESSING HANDOFF CONFIRM MESSAGES

(75) Inventors: Jianquan Song, Shenzhen (CN); Ling Xu, Shenzhen (CN); Li Chu, Shenzhen (CN)

(73) Assignee: ZTE Corporation, Shenzhen, Guangdong (CN)

(21) Appl. No.: 12/672,917

(22) PCT Filed: Oct. 10, 2008
(86) PCT No.: PCT/CN08/72658

§ 371 Date: Feb. 10, 2010

(30) Foreign Application Priority Data
Oct. 15, 2007 (CN) 200710180320.X

(51) Int. Cl. H04W 36/26

(52) U.S. Cl. 455/437

(57) ABSTRACT

The present invention provides a method for processing handoff confirm messages. The method includes the following steps: step S102, a serving base station receives a handoff indication message which is from a terminal, and determines the content of the field of the HO confirm type in the handoff confirm message which is to be transferred; and step S104, the serving base station determines whether the service flow information or terminal identifiers are included or not when the handoff confirm messages are transferred to multiple target base stations or target ASNs according to the field of the HO confirm type. The method for processing handoff confirm messages makes handoff among different branches according to different contents in the same controlling procedure, the redundant messages are reduced, and the transmission efficiency of link controlling information and the processing efficiency of the receiving end are improved effectively.

### TECHNICAL FIELD

The present invention relates to the field of communications, and relates more particularly to a method for processing handoff confirm messages.

### BACKGROUND

In wireless communication systems, different control entities are required to transmit control information to each other so as to coordinately accomplish a certain function. As the control entity within the network is responsible for more and more functions and has larger and larger user capacity, the load of the control information that needs to be transmitted is becoming higher and higher. How to improve the efficiency of information transmission on the link becomes an urgent problem to be solved. Meanwhile, as more and more control information contents being transmitted, how to effectively improve the processing efficiency of a receiving end becomes a problem that must be solved.

Generally, a method for solving a problem of transmission efficiency can be considered from the perspective of information transmission, for example, how to unpack/pack to guarantee the most efficient transmission. Moreover, a method for improving the processing efficiency of the receiving end can be also considered from the perspective of information transmission. However, in practice, some control flows have the following features:

In wireless communication systems, many identical message names can be used in different situations, taking an HO_Cnf (Handoff Confirm) message in handoff action phase of IEEE802.16 system for example, the message can be used in four situations: Confirm, Unconfirm, Cancel, and Reject, which are indicated respectively by the field of an HO confirm type in the message. After receiving the message, the receiving end accordingly takes the next step by analyzing the content of the field.

At present, this kind of message also includes some indispensable fields related to a service flow (SF), such as a service flow identifier, a service flow direction, a classifier regulation index (whether it is indispensable or not is depend on a tunnel granularity of R4, R6, or R8), a classifier regulation priority (whether it is indispensable or not is depend on tunnel granularity of R4, R6, or R8), and QoS (Quality of Service) parameters. These fields are used to assist the receiving end to acquire corresponding information when the handoff succeeds, so as to take the next step.

In general, the handoff is divided into two phases, namely a handoff preparation phase and a handoff action phase.

During the handoff preparation phase, a data path pre-registration procedure can be implemented, or the pre-registration procedure can be deferred to be implemented during the handoff action phase; if the data path pre-registration procedure is to be implemented during the handoff preparation phase, it is necessary in relevant messages to include relevant information of all service flows of the terminal. The relevant messages include a handoff request message, a handoff response message or a data path pre-registration request message, and a data path pre-registration response message. One terminal may have multiple service flows; under the NWG1.1.1 specification, the relation between the service flow and the data path is one-to-one. Under this case, the data path information is included in the service flow information.

During the handoff action phase, according to the content of a MOB_HO_IND (Mobile Handoff Indication) message received from the terminal through an air interface, a serving base station determines the value of the HO confirm type in the HO_Cnf that is to be sent.

(1) If the MOB_HO_IND message sent by the terminal indicates that the mobile station (MS) has selected one target base station, then the HO confirm type in the HO_Cnf message that is sent to the selected target base station (or the selected target access service network, ASN) by the serving base station is set as “Confirm”. Meanwhile, the HO confirm type in the HO_Cnf message that is sent to the unselected target base station (or the unselected target ASN) by the serving base station is set as “Cancel”.

(2) If the MOB_HO_IND message indicates that the MS cancels the handoff, then the HO confirm types in the HO_Cnf messages which are sent to ail target base stations (or target ASNs) by the serving base station (or the service ASN) are set as “Cancel”.

(3) If the MOB_HO_IND message indicates that MS rejects the handoff, then the HO confirm types in the HO_Cnf messages which are sent to all target base stations (or target ASNs) by the serving base station (or the service ASN) are set as “Reject”.

(4) If the MOB_HO_IND message is not received, then the HO confirm types in the HO_Cnf messages which are sent to all target serving base stations (or target ASNs) by the serving base station (or the service ASN) are set as “Unconfirm”.

According to the protocol handoff procedure, only when the HO confirm type in the HO_Cnf message that is sent to the target base station by the serving base station is set as “Confirm” or “Unconfirm”, it is possible for the terminal to successfully access one target base station, therefore the relevant fields of all service flows of the terminal need to be included in the HO-Cnf message.

According to the protocol handoff procedure, when the HO confirm type in the HO_Cnf message that is sent to the target base station by the serving base station is set as “Cancel” or “Reject”, there are two situations as following:

(1) If the data path pre-registration procedure is not implemented during the handoff preparation phase, then it means that there is no resource to be released. Accordingly, there is no need to include the relevant fields of the service flows of the terminal in the HO-Cnf message.

(2) If the data path pre-registration procedure has been implemented during the handoff preparation phase, then it is required to release the resources allocated to the service flows of the terminal during the data path pre-registration procedure; the service flows contained in the terminal during the data path pre-registration procedure are known, if the relevant messages of the data path pre-registration procedure have indicated the terminal and inclusive service flows in the terminal, then the HO-Cnf message is just required to include a terminal identifier, at this moment, after receiving the message, the target base station then releases resources of the service flows related to the terminal identifier, thus the relevant fields of the service flows of the terminal are not required to be included in the HO-Cnf message.

However, in the current protocol message procedure, for the unselected target base stations or the target base stations which are under the situation that the whole handoff is canceled or rejected, the serving base station still make the HO-Cnf message include the relevant fields of all service flows of the terminal, thereby generating a lot of unnecessary overhead; moreover, the receiving end is also required to parse all information contents in the message, and then makes corresponding processing. Supposing that three target base stations are selected and two service flows are contained in the terminal, for every handoff, if the handoff is successful, it is necessary to send handoff cancellation notices to two of the target base stations, and according to the current protocol, the message is required to include 9×N invalid fields, wherein N is the number of the service flows. In regions with more frequent handoff, such a design brings a lot of redundant and useless information to network links. Moreover, a lot of useless parsing work also needs to be done in the receiving end.

### SUMMARY

In view of the above descriptions, intending to solve the problem of huge unnecessary expense caused by the fact that HO-Cnf messages in the above four handoff processes are all required to include relevant fields of all service flows of the terminal, the present invention provides a method for processing handoff confirm messages, according to different situations, making the message procedures adjust accordingly, and also making the included message contents adapt accordingly. Thus the efficiency of the message transmission on the network side is improved. Moreover, the contents that need to be processed by the receiving end are also processed in different ways according to the different procedures, and the processing efficiency is improved.

A method for processing handoff confirm messages according to one aspect of the present invention comprises the following steps: step S102, a serving base station receives a handoff indication message from a terminal, and according to the handoff indication message determines the content of the field of an HO confirm type in a handoff confirm message that is to be sent; and step S104, according to the content of the field of the HO confirm type, the serving base station determines whether to include service flow information or terminal identifiers in the handoff confirm messages when it sends them to multiple target base stations or target ASNs.

This invention also provides an information transmission method based on the above method for processing handoff confirm messages. The method comprises the following process: after receiving the handoff confirm message, the target base station or target ASN performs corresponding operations according to the handoff confirm message.

A method for processing handoff confirm messages according to another aspect of the present invention comprises the following processes: a serving base station receives a handoff indication message from a terminal, and according to the handoff indication message, the handoff confirm messages which are to be sent are divided into a confirmed-handoff confirm message, an unconfirmed-handoff confirm message, a cancelled-handoff confirm message and a rejected-handoff confirm message, and the handoff confirm message is sent to the target base station or the target ASN. Wherein, the confirmed-handoff confirm message and the unconfirmed-handoff confirm message include service flow information while being sent, and the cancelled-handoff confirm message and the rejected-handoff confirm message include a terminal identifier while being sent.

This invention also provides an information transmission method based on the above method for processing handoff confirm messages, and the method comprises the following process: after receiving the handoff confirm message, the target base station or target ASN performs corresponding operations according to the handoff confirm message.

According to the method for processing handoff confirm messages of the present invention, in the same control procedure, redundant information to be included is greatly reduced by handoff among different branches according to different message contents, and the transmission efficiency of link control information and the processing efficiency of the receiving end are improved effectively.

### BRIEF DESCRIPTION OF THE DRAWINGS

FIG. 1 is a flow chart illustrating the method for processing the handoff confirm message according to an embodiment of the present invention;

FIG. 2 is a flow chart illustrating the method for processing the handoff confirm message according to a preferred embodiment of the present invention, under the condition that the handoff indication message from a mobile phone indicates that a target base station TBS 1 is selected;

FIG. 3 is a flow chart illustrating the method for processing the handoff confirm message according to a preferred embodiment of the present invention, under the condition that the handoff indication message from a mobile phone indicates that the MS cancels the handoff;

FIG. 4 is a flow chart illustrating the method for processing the handoff confirm message according to a preferred embodiment of the present invention, under the condition that the handoff indication message from a mobile phone indicates that the MS rejects the handoff;

FIG. 5 is a flow chart illustrating the method for processing the handoff confirm message according to a preferred embodiment of the present invention, under the condition that the handoff indication message from a mobile phone is lost;

FIG. 6 is a flow chart illustrating the method for processing the handoff confirm message according to another preferred embodiment of the present invention, under the condition that the handoff indication message from a mobile phone indicates that a target base station TBS 1 is selected;

FIG. 7 is a flow chart illustrating the method for processing the handoff confirm message according to another preferred embodiment of the present invention, under the condition that the handoff indication message from a mobile phone indicates that the MS cancels the handoff;

FIG. 8 is a flow chart illustrating the method for processing the handoff confirm message according to another preferred embodiment of the present invention, under the condition that the handoff indication message from a mobile phone indicates that the MS rejects the handoff; and

FIG. 9 is a flow chart illustrating the method for processing the handoff confirm message according to another preferred embodiment of the present invention, under the condition that the handoff indication message from a mobile phone is lost.

### DETAILED DESCRIPTION

Function Summary

As in current technology, HO-Cnf messages sent by a serving base station are required to include relevant fields of all service flows of a terminal, and for this reason, the tremendous redundant and useless information is brought into network links, thus leading to huge amount of unnecessary expense. To solve this problem, the present invention provides a method for processing the handoff confirm messages: according to different situations, message flows make different adjustments, and message contents being included also make different adoptions accordingly. As a result, the efficiency of the message transmission in the network is improved. Meanwhile, the contents that need to be processed by a receiving end are also processed in different ways according to different flows, thus the processing efficiency is improved.

Embodiments of the present invention will be described in detail hereinafter.

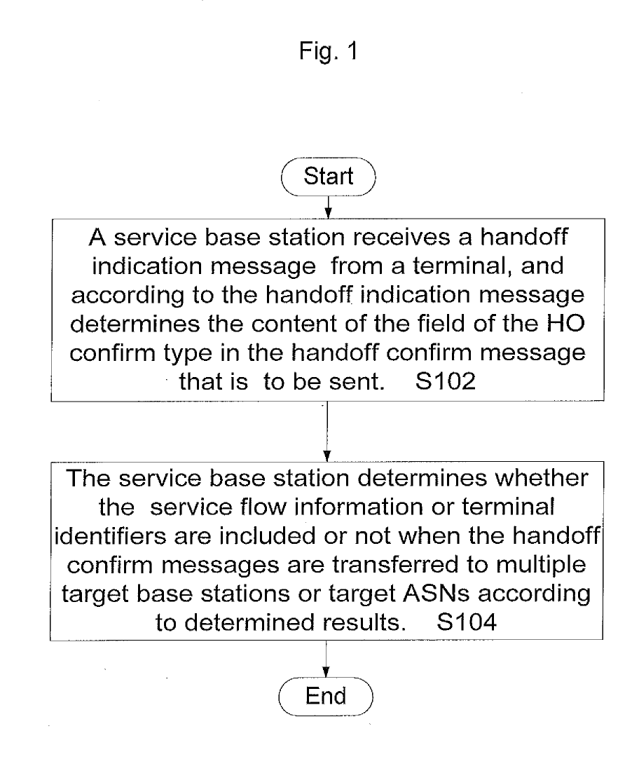

A method for processing handoff confirm messages is provided according to an embodiment of the present invention. FIG. 1 is a flow chart illustrating the method for processing the handoff confirm message according to the embodiment of the present invention. As illustrated in FIG. 1, the method comprises the following steps:

step S102, after receiving a MOB_HO_IND (handoff indication) message sent by a terminal, and according to the information included in the message, a serving base station determines the contents of the HO confirm types in the HO-Cnf messages which are to be sent to multiple target base stations or target ASNs; and

step S104, according to the determined contents of the HO confirm types in the HO-Cnf messages, the serving base station determines whether to include service flow information or terminal identifiers in the HO-Cnf messages when it sends them to multiple target base stations or target ASNs.

The present invention also provides an information transmission method based on the above method for processing the handoff confirm messages, including the following process: after receiving the HO_Cnf message, the target base station or the target ASN performs corresponding operations according to the HO_Cnf message and other information being included.

Further, according to the MOB_HO_IND message sent by the mobile station (MS), if the message indicates that the MS has selected a target base station, according to the message, the serving base station sets the HO confirm type in the HO_Cnf message that is sent to the target base station (or the target ASN) as “Confirm”, and the confirmed service flow information is included at the same time. Meanwhile, the serving base station is also required to send the HO_Cnf messages to other unselected target base stations (or the target ASNs), and sets the HO confirm types in the messages as “Cancel”, and at least the MS identifiers involved in this handoff cancellation are included at the same time.

If the MOB_HO_IND received by the serving base station indicates that the MS cancels the handoff, then the HO confirm types in the HO_Cnf messages which are sent to all target service stations (or target ASNs) by the serving base station (or the service ASN) are set as “Cancel”, and at the same time the MS identifiers corresponding to handoff cancellation are included in the HO_Cnf messages.

If the MOB_HO_IND received by the serving base station indicates that the MS rejects the handoff, then the HO confirm types in the HO_Cnf messages which are sent to all target service stations (or target ASNs) by the serving base station (or the service ASN) are set as “Reject”, and at the same time the MS identifiers corresponding to handoff rejection are included in the HO_Cnf messages.

If the serving base station does not receive the MOB_HO_IND message, the HO confirm types in the HO_Cnf messages which are sent to all target base stations (or target ASNs) by the serving base station (or the service ASN) are set as “Unconfirm”, and at the same time the confirmed service flow information is included in the HO_Cnf messages.

Further, after receiving the HO_Cnf message sent by the serving base station, the target base station determines the content of the HO confirm type in the message. If the content is “Cancel” or “Reject”, the target station releases the resources occupied during the handoff preparation phase according to the MS identifier included in the message.

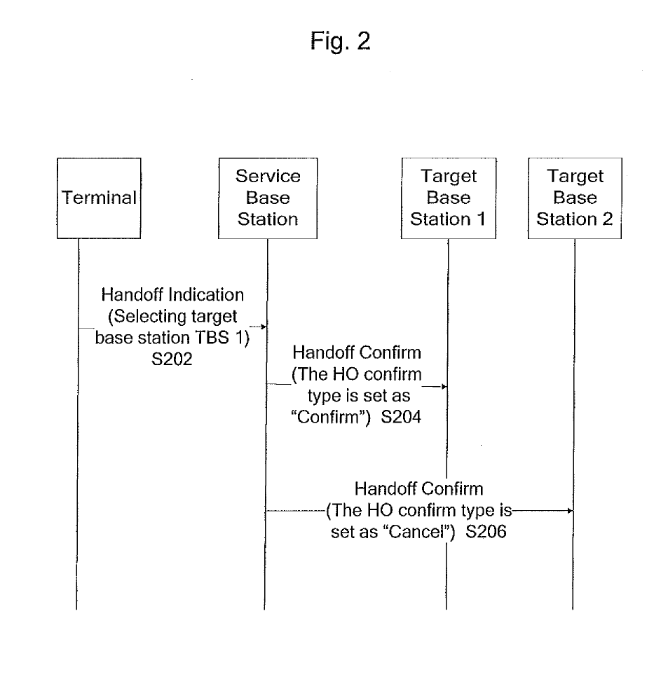

To simplify the figure, two candidate target base stations are selected, as illustrated in FIG. 2, and those are TBS1 and TBS2 respectively. And the above terminal may be a mobile phone in the following embodiments.

FIG. 2 is a flow chart illustrating the method for processing the handoff confirm message according to a preferred embodiment of the present invention, under the condition that a handoff indication message from a mobile phone indicates that a target base station TBS 1 is selected. As illustrated in FIG. 2, the method comprises the following steps:

step S202, a mobile phone sends a handoff indication message to a serving base station (SBS), and the handoff indication message indicates that the MS has successfully selected a target base station TBS 1;

step S204, after receiving the handoff indication message, the serving base station sends a handoff confirm message in which an HO confirm type is set as “Confirm” to the target base station 1 (TBS 1), and at the same time the message includes the confirmed service flow information; and

step S206, after receiving the handoff confirm message, the serving base station sends a handoff confirm message in which the HO confirm type is set as “Cancel” to the target base station TBS 2, and the message includes at least the MS identifier involved in this handoff cancellation.

There is no time order for step S204 and step S206, as long as they follow step S202.

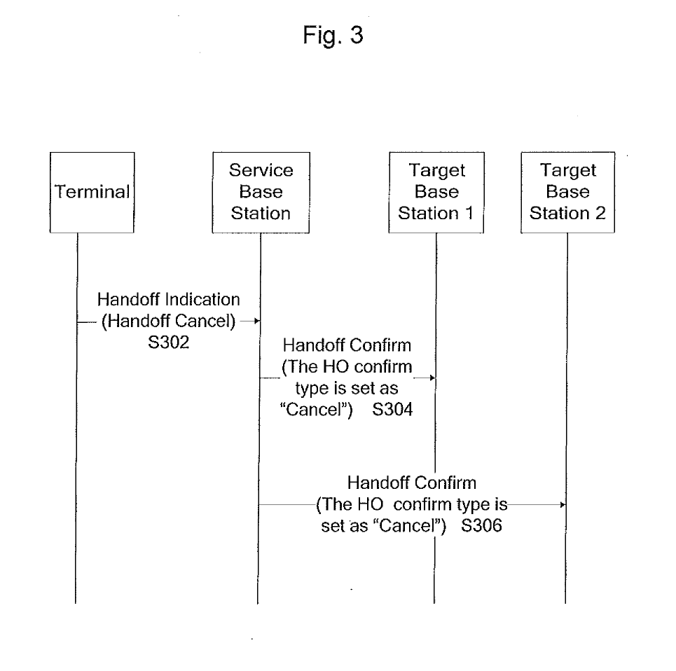

FIG. 3 is a flow chart illustrating the method for processing the handoff confirm message according to a preferred embodiment of the present invention, under the condition that the handoff indication message from a mobile phone indicates that the MS cancels the handoff. As illustrated in FIG. 3, the method comprises the following steps:

step S302, a mobile phone sends a handoff indication message to a serving base station, and the handoff indication message indicates that the MS cancels this handoff;

step S304, after receiving the handoff indication message, the serving base station sends a handoff confirm message in which the HO confirm type is set as “Cancel” to a target base station TBS 1, and the message includes at least the MS identifier involved in this handoff cancellation; and

step S306, after receiving the handoff indication message, the serving base station sends a handoff confirm message in which the HO confirm type is set as “Cancel” to the target base station TBS 2, and the message includes at least the MS identifier involved in this handoff cancellation.

There is no time order for step S304 and step S306, as long as they follow step S302.

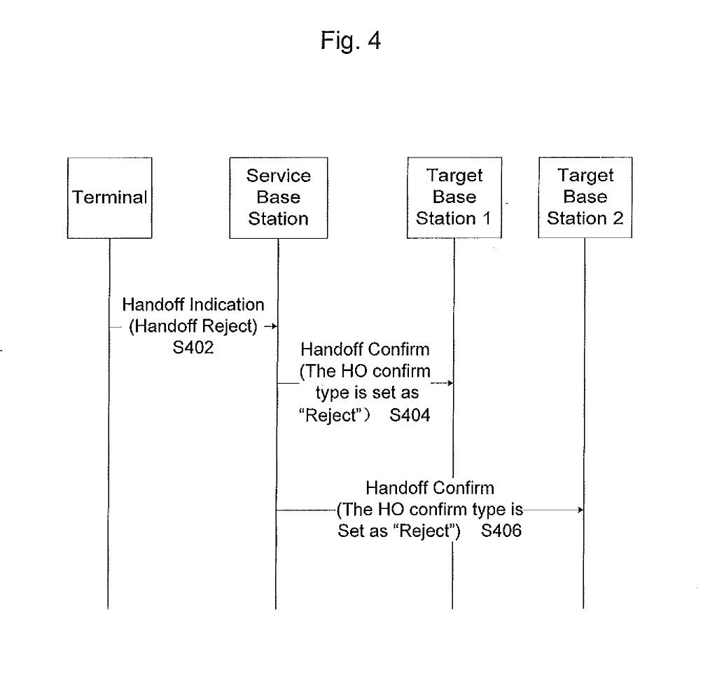

FIG. 4 is a flow chart illustrating the method for processing the handoff confirm message according to a preferred embodiment of the present invention, under the condition that the handoff indication message from a mobile phone indicates that the MS rejects the handoff. As illustrated in FIG. 4, the method comprises the following steps:

step S402, a mobile phone sends a handoff indication message to a serving base station, and the handoff indication message indicates that the MS rejects this handoff;

step S404, after receiving the handoff indication message, the serving base station sends a handoff confirm message in which the HO confirm type is set as “Reject” to a target base station TBS 1, and the message includes at least the MS identifier involved in this handoff rejection; and

step S406, after receiving the handoff indication message, the serving base station sends a handoff confirm message in which the OH confirm type is set as “Reject” to the target base station TBS 2, and the message includes at least the MS identifier involved in this handoff rejection.

There is no time order for step S404 and step S406, as long as they follow step S402.

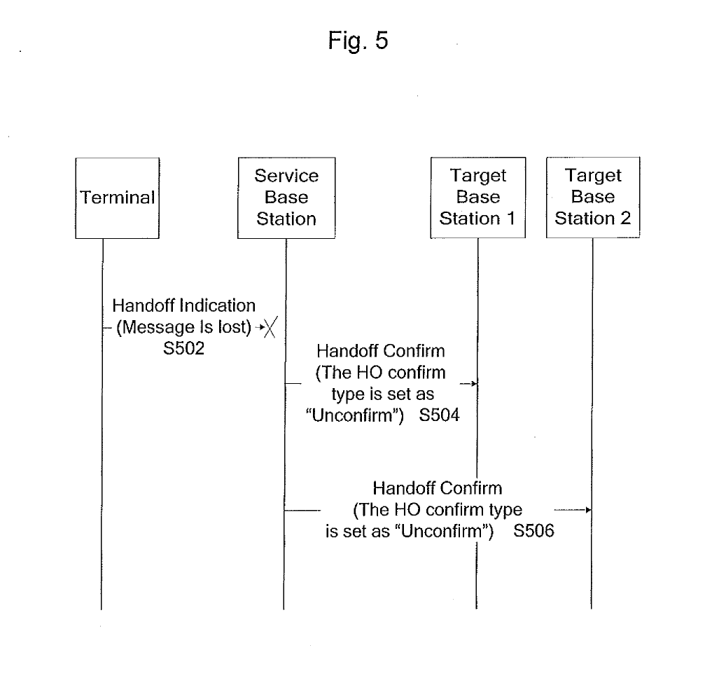

FIG. 5 is a flow chart illustrating the method processing for the handoff confirm message according to a preferred embodiment of the present invention, under the condition that the handoff indication message from a mobile phone is lost. As illustrated in FIG. 5, the method comprises the following steps:

step S502, a mobile phone sends a handoff indication message to a serving base station, and the handoff indication message is lost in the air;

step S504, if the timer that the serving base station waiting for a handoff indication message is overtime and the serving base station has not received the handoff indication message, the serving base station then sends a handoff confirm message in which the HO confirm type is set as “Unconfirm” to a target base station TBS 1. As the terminal may successfully access one target base station, the message at the same time includes the confirmed service flow information; and

step S506, if the timer that the serving base station waiting for a handoff indication message is overtime and the serving base station has not received the handoff indication message, the serving base station sends a handoff confirm message in which the HO confirm type is set as “Unconfirm” to the target base station TBS 2, and the message includes the confirmed service flow information at the same time.

There is no time order for step S504 and step S 506, as long as they follow step S502.

According to another embodiment of the present invention, an optimizing method for a handoff flow is provided, including the following processes: according to possible circumstances in the handoff flow, a serving base station sends different types of handoff confirm messages to a target base station: a confirmed-handoff confirm message, an unconfirmed-handoff confirm message, a cancelled-handoff confirm message, and a rejected-handoff confirm message; thus it is necessary to include fields related to the service flows in the confirmed-handoff confirm message and the unconfirmed-handoff confirm message; and it is required to include at least the corresponding terminal identifiers in the cancelled-handoff confirm message and the rejected-handoff confirm message.

Further, according to a MOB_HO_IND message sent by a MS, if the message indicates that the MS has selected a target base station, the serving base station sends the confirmed-handoff confirm message to the target base station (or the target ASN), and the message includes the confirmed service flow information at the same time. Meanwhile, the serving base station sends the cancelled-handoff confirm message to other unselected target base stations (or target ASNs), and the messages include at least the MS identifiers which are corresponding to the handoff cancellation at the same time.

If the MOB_HO_IND received by the serving base station indicates that the MS cancels this handoff, then the serving base station (or the service ASN) sends the cancelled-handoff confirm messages to all target base stations (or target ASNs). Meanwhile the messages include at least the MS identifiers which are corresponding to the handoff cancellation.

If the MOB_HO_IND received by the serving base station indicates that the MS rejects this handoff, then the serving base station (or the service ASN) sends the rejected-handoff confirm messages to all target base stations (or target ASNs), meanwhile the messages include the MS identifiers corresponding to the handoff rejection.

If the serving base station does not receive the MOB_HO_IND message, then the serving base station (or the service ASN) sends the unconfirmed-handoff confirm messages to all target base stations (or target ASNs), meanwhile the messages include the confirmed service flow information.

According to the optimizing method for a handoff flow of the present invention, in the same control flow, the included redundant information is greatly reduced by the handoff among different branches according to different message contents, and thus the transmission efficiency of link control information and the processing efficiency of a receiving end are improved remarkably.

The present invention also provides an information transmission method based on the above method for processing handoff confirm message. The method comprises the following process: after receiving the handoff confirm message, the target base station or the target ASN performs corresponding operations according to the handoff confirm message.

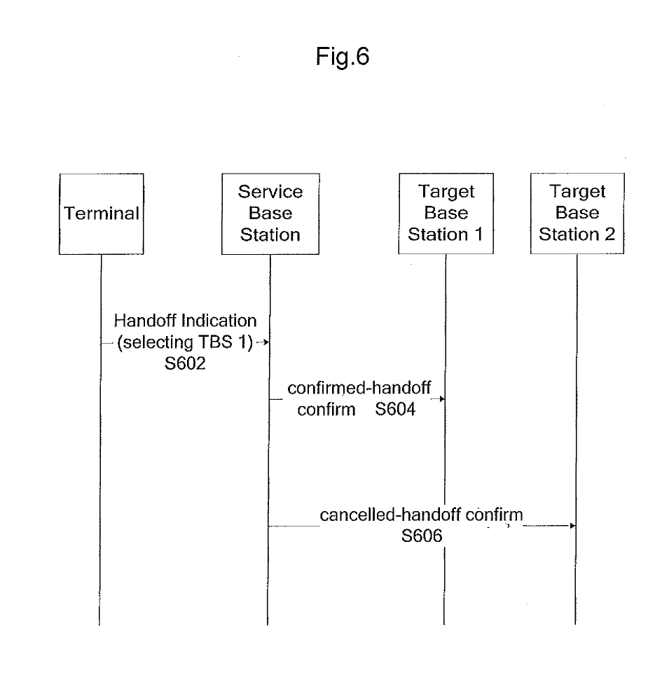

FIG. 6 is a flow chart illustrating the method for processing the handoff confirm message according to a preferred embodiment of the present invention, under the condition that a handoff indication message from a mobile phone indicates that a target base station TBS 1 is selected. As illustrated in FIG. 6, the method comprises the following steps:

step S602, a mobile phone sends a handoff indication message to a serving base station, and the handoff indication message indicates that the MS has successfully selected a target base station TBS 1;

step S604, after receiving the handoff indication message, the serving base station sends a confirmed-handoff confirm message to the selected target base station TBS 1, and the message includes the confirmed service flow information at the same time; and

step S606, after receiving the handoff indication message, the serving base station sends a cancelled-handoff confirm message to the unselected target base station TBS 2, and the message includes at least the MS identifier involved in this handoff cancellation.

There is no time order for step S604 and step S606, as long as they follow step S602.

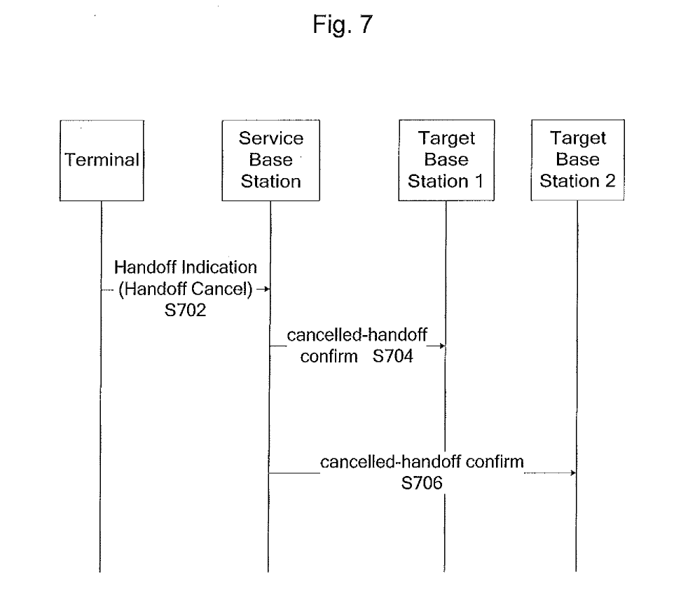

FIG. 7 is a flow chart illustrating the method for processing the handoff confirm message according to another preferred embodiment of the present invention, under the condition that a handoff indication message from a mobile phone indicates that the MS cancels this handoff. As illustrated in FIG. 7, the method comprises the following steps:

step S702, a mobile phone sends a handoff indication message to a serving base station, and the handoff indication message indicates that the MS cancels this handoff;

step S704, after receiving the handoff indication message, the serving base station sends a cancelled-handoff confirm message to the target base station TBS 1, and the message includes at least the MS identifier involved in this handoff cancellation; and

step S706, after receiving the handoff indication message, the serving base station sends a cancelled-handoff confirm message to the target base station TBS 2, and the message includes at least the MS identifier involved in this handoff cancellation.

There is no time order for step S704 and step S706, as long as they follow step S702.

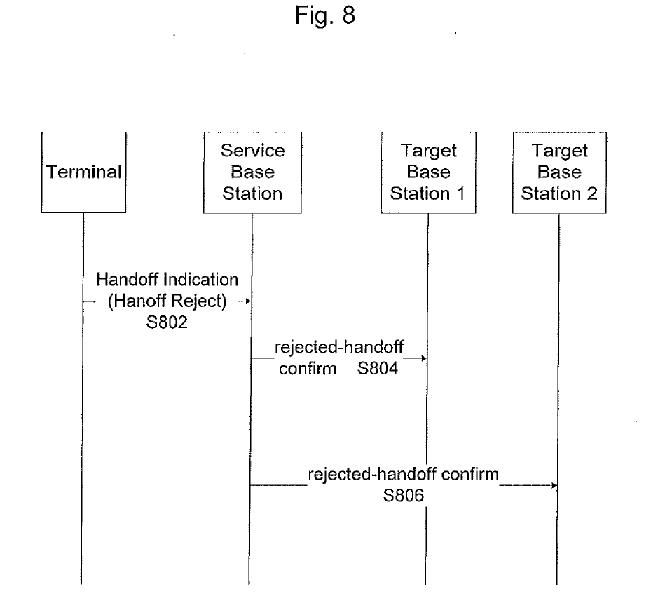

FIG. 8 is a flow chart illustrating the method for processing the handoff confirm message according to another preferred embodiment of the present invention, in which a handoff indication message from a mobile phone indicates that the MS rejects the handoff. As illustrated in FIG. 8, this method comprises the following steps:

step S802, a mobile phone sends a handoff indication message to a serving base station, and the handoff indication message indicates that the MS rejects this handoff;

step S804, after receiving the handoff indication message, the serving base station sends a rejected-handoff confirm message to the target base station TBS 1, and the message includes at least the MS identifier involved in this handoff rejection; and

step S806, after receiving the handoff indication message, the serving base station sends a rejected-handoff confirm message to the target base station TBS 2, and the message includes at least the MS identifier involved in this handoff rejection.

There is no time order for step S804 and step S806, as long as they follow step S802.

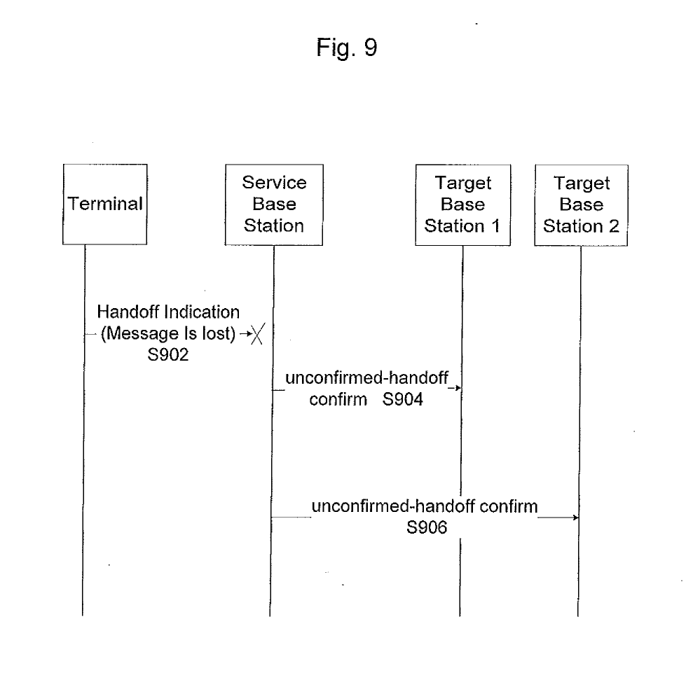

FIG. 9 is a flow chart illustrating the method for processing the handoff confirm message according to another preferred embodiment of the present invention, under the condition that a handoff indication message from a mobile phone is lost. As illustrated in FIG. 9, the method comprises the following steps:

step S902, a mobile phone sends a handoff indication message to a serving base station SBS, and the handoff indication message is lost in the air;

step S904, if the timer that the serving base station waiting for a handoff indication message is overtime and the serving base station has not received the handoff indication message, the serving base station sends an unconfirmed-handoff confirm message to the target base station TBS 1, and the message includes the confirmed service flow information at the same time; and

step S906, if the timer that the serving base station waiting for a handoff indication message is overtime and the serving base station has not received the handoff indication message, the serving base station sends an unconfirmed-handoff confirm message to the target base station TBS 2, and the message includes the confirmed service flow information at the same time.

There is no time order for step S904 and step S906, as long as they follow step S902.

The use of the HO-Cnf messages in the current protocol can be optimized by the method for processing the handoff confirm message of the present invention, which greatly reduce the expense in message transmission. As a result, the increasing service flows exist in a terminal, the larger expense can be saved.

The above illustrative examples are just preferred embodiments of the present invention, but are not used to limit the invention. For those skilled in the art, various modifications and changes can be made to the present invention. Any modification, equivalent substitution, or improvement within the spirit and principle of the invention, shall be included in the protection scope of the present invention.

1. A method for processing handoff confirm messages comprising the following steps:
step S102, a serving base station receiving a handoff indication message from a terminal and, according to the handoff indication message, determining the content of the field of an HO confirm type in the handoff confirm message which is to be sent; and
step S104, according to the content of the field of the HO confirm type, the serving base station determining whether to include service flow information or terminal identifiers in the handoff confirm messages when it sends them to multiple target base stations or target access service networks.

2. The method for processing handoff confirm messages according to claim 1, wherein,
in the step S102, if the handoff indication message indicates that the terminal has selected a target base station or a target access service network, then the content of the field of the HO confirm type is set as “Confirm” or “Cancel”;
the step S104 includes that:
the serving base station sends the handoff confirm message in which the content of the field of the HO confirm type is set as “Confirm” to the selected target base station or the selected target access service network, and the service flow information is included in the handoff confirm message;
the serving base station sends the handoff confirm message in which the content of the field of the HO confirm type is set as “Cancel” to an unselected target base stations or an unselected target access service networks, and the terminal identifier of cancelling handoff is included in the handoff confirm message.

3. The method for processing handoff confirm messages according to claim 1, wherein,
in the step S102, if the handoff indication message indicates that the terminal cancels the handoff, then the content of the field of the HO confirm type is set as “Cancel”;
the step S104 includes that:
the serving base station sends the handoff confirm messages in which the contents of the fields of the HO confirm types are set as “Cancel” to all target base stations or all target access service networks, and the handoff confirm message includes the terminal identifier of cancelling handoff while being sent.

4. The method for processing handoff confirm messages according to claim 1, wherein,
in the step S102, if the handoff indication message indicates that the terminal rejects the handoff, then the content of the field of the HO confirm type is set as “Reject”;
the step S104 includes that:
the serving base station sends the handoff confirm messages in which the contents of the fields of the HO confirm types are set as “Reject” to all target base stations or all target access service networks, and the handoff confirm message includes the terminal identifier of rejecting handoff while being sent.

5. The method for processing handoff confirm messages according to claim 1, further comprising the following process:
if the handoff indication message is not received, the serving base station sending the handoff confirm messages in which the contents of the fields of the HO confirm types are set as “Unconfirm” to all target base stations or all target access service networks, and the handoff confirm message including the service flow information while being sent.

6. The method for processing handoff confirm messages according to claim 1, further comprising the following process:
after receiving the handoff confirm message, if the content of the field of the HO confirm type is set as “Cancel” or “Reject”, the target base station or the target access service network releasing resources occupied during a handoff preparation phase according to the terminal identifier.

7. An information transmission based on the method for processing handoff confirm messages according to claim 1, comprising the following process:
after receiving the handoff confirm message, the target base station or the target access service network performing corresponding operations according to the handoff confirm message.

8. A method for processing handoff confirm messages, comprising the following processes:
a serving base station receiving a handoff indication message from a terminal and, according to the received handoff indication message, classifying the handoff confirm messages which are to be sent as a confirmed-handoff confirm message, an unconfirmed-handoff confirm message, a cancelled-handoff confirm message and a rejected-handoff confirm message, and sending the handoff confirm message to target base station or target access service network; wherein, the confirmed-handoff confirm message and the unconfirmed-handoff confirm message include service flow information while being sent, and the cancelled-handoff confirm message and the rejected-handoff confirm message include a terminal identifier while being sent.

9. The method for processing handoff confirm messages according to claim 8, wherein, after the serving base station confirming that the handoff indication message indicates that the terminal has selected the specified target base station or the specified target access service network, the step that the confirmed-handoff confirm message and the unconfirmed-handoff confirm message include the service flow information while being sent and that, the cancelled-handoff confirm message and the rejected-handoff confirm message include the terminal identifier while being sent, comprising the following processes:
the serving base station sends the confirmed-handoff confirm message to the selected target base station or the selected target access service network, and the confirmed-handoff confirm message includes the service flow information while being sent; the serving base station sends the cancelled-handoff confirm message to the unselected target base station or the unselected target access service network, and the cancelled-handoff confirm message includes the terminal identifier of cancelling handoff while being sent.

10. The method for processing handoff confirm messages according to claim 8, wherein, after the serving base station confirming that the handoff indication message indicates that the terminal cancels the handoff, the step that the confirmed-handoff confirm message and the unconfirmed-handoff confirm message include the service flow information while being sent and that, the cancelled-handoff confirm message and the rejected-handoff confirm message include the terminal identifier while being sent, comprising the following process:
the serving base station sends the cancelled-handoff confirm messages to all target base stations or all target access service networks, and the cancelled-handoff confirm message includes the terminal identifier of cancelling handoff while being sent.

11. The method for processing handoff confirm messages according to claim 8, wherein, after the serving base station confirming that the handoff indication message indicates that the terminal rejects the handoff, the step that the confirmed-handoff confirm message and the unconfirmed-handoff confirm message include the service flow information while being sent and that, the cancelled-handoff confirm message and the rejected confirm message include the terminal identifier while being sent, comprising the following process:
the serving base station sends the rejected-handoff confirm messages to all target base stations or all target access service networks, and the rejected-handoff confirm message includes the terminal identifier of rejecting handoff while being sent.

12. The method for processing handoff confirm messages according to claim 8, further comprising the following process:
if the handoff indication message is not received, the serving base station sending the unconfirmed-handoff confirm messages to all target base stations or all target access service networks; and the unconfirmed-handoff confirm messages including the service flow information while being sent.

13. An information transmission method based on the method for processing handoff confirm messages according to claim 8, comprising the following process:
according to the handoff confirm message, the target base station or the target access service network performs corresponding operations after receiving the handoff confirm message.

14. The method for processing handoff confirm messages according to claim 2, further comprising the following process:
after receiving the handoff confirm message, if the content of the field of the HO confirm type is set as “Cancel” or “Reject”, the target base station or the target access service network releasing resources occupied during a handoff preparation phase according to the terminal identifier.

15. The method for processing handoff confirm messages according to claim 3, further comprising the following process:
after receiving the handoff confirm message, if the content of the field of the HO confirm type is set as “Cancel” or “Reject”, the target base station or the target access service network releasing resources occupied during a handoff preparation phase according to the terminal identifier.

16. The method for processing handoff confirm messages according to claim 4, further comprising the following process:
after receiving the handoff confirm message, if the content of the field of the HO confirm type is set as “Cancel” or “Reject”, the target base station or the target access service network releasing resources occupied during a handoff preparation phase according to the terminal identifier.

17. The method for processing handoff confirm messages according to claim 5, further comprising the following process:
after receiving the handoff confirm message, if the content of the field of the HO confirm type is set as “Cancel” or “Reject”, the target base station or the target access service network releasing resources occupied during a handoff preparation phase according to the terminal identifier.

18. An information transmission based on the method for processing handoff confirm messages according to claim 2, comprising the following process:
after receiving the handoff confirm message, the target base station or the target access service network performing corresponding operations according to the handoff confirm message.

19. An information transmission based on the method for processing handoff confirm messages according to claim 3, comprising the following process:
after receiving the handoff confirm message, the target base station or the target access service network performing corresponding operations according to the handoff confirm message.

20. An information transmission based on the method for processing handoff confirm messages according to claim 4, comprising the following process:
after receiving the handoff confirm message, the target base station or the target access service network performing corresponding operations according to the handoff confirm message.
